(19) United States
(12) Patent Application Publication
(10) Pub. No.: US 2016/0342706 A1
(43) Pub. Date: Nov. 24, 2016

(54) SYSTEM AND METHOD FOR ADDING NOISE TO n-GRAM STATISTICS

(71) Applicant: Xerox Corporation, Norwalk, CT (US)

(72) Inventor: Matthias Gallé, Saint Martin d'Heres (FR)

(21) Appl. No.: 14/714,567

(22) Filed: May 18, 2015

(51) Int. Cl. G06F 17/30; G06F 17/18

(52) U.S. Cl. CPC G06F 17/30958; G06F 17/18

(57) ABSTRACT

A system and method modify n-gram statistics to allow their release by inhibiting reconstruction of a sequence from which they are derived. n-gram statistics for the sequence are obtained which include, for each of a set of n-grams, an associated measure of occurrence in the sequence. An initial directed graph is generated from the n-gram statistics. The graph includes nodes connected by edges, each of the edges corresponding to one of the n-grams in the set of n-grams. The edge is associated with a multiplicity which is based on the measure of occurrence. A modified directed graph is generated. This includes adding a plurality of edges to the initial directed graph. These added edges correspond to n-grams that are not present in the sequence of symbols and are each associated with a multiplicity. Modified n-gram statistics for the modified directed graph are generated. The modified n-gram statistics include, for n-grams represented in the modified directed graph, an associated measure of occurrence.

### BACKGROUND

The exemplary embodiment relates to n-gram statistics generated from documents. It finds particular application in connection with a system and method for modifying n-gram statistics for inhibiting document reconstruction from the statistics.

Organizations often see advantages to releasing part of the data they own for reasons of general good, prestige, harnessing the work of those to whom the data is released, or to open access to new resources for financial gain. It may not be feasible to release the data in its original form due to privacy concerns, legal constraints, or economic interest. In such cases, a compromise is to release some statistics computed over the data. For example the statistics released may include n-gram counts for text documents. Here, n-grams are sequences of words of length n words. Examples of the production of such information include the release of copyrighted material (for example, the Google Ngram Corpus) and the exchange of phrase tables for machine translation when the original parallel corpora are private or confidential.

However, there has been considerable interest in trying to reconstruct at least part of a document, given the count of all its n-grams, as disclosed, for example in Matias Tealdi and Matthias Gallé, “Reconstructing documents from perfect n-gram information,” SeqBio, pp. 41-42, 2013, and U.S. application Ser. No. 14/083,483, filed on Nov. 19, 2013, entitled RECONSTRUCTING DOCUMENTS FROM n-GRAM INFORMATION, by Tealdi and Gallé (hereinafter, collectively referred to as Tealdi and Gallé). The method enables reconstruction of parts of a document from the set of its n-grams and their respective counts. The possibility of retrieving large chunks of the original document with absolute certainty is feasible only when the complete n-gram data (this is, all n-grams and their respective counts) is released. In the method of Tealdi and Gallé, a de Bruijn graph of the given n-grams is constructed. In the graph, each n-gram becomes an edge between two nodes, each one denoting an n−1-gram. Each edge is associated with a multiplicity, denoting the number of times it occurs in the corpus. Any Eulerian path through such a graph therefore denotes a plausible document that would produce a n-gram set as the one provided as input. Two reduction steps are used to merge adjacent edges, whenever certain conditions are achieved, that ensure that such a merge corresponds to a substring which has to exist in the original corpus (that is, two edges are merged if and only if any Eulerian path has to transverse these edges sequentially). This allows iterative reconstruction of chunks of text that are larger than size n. It can be shown that the iterative application of these two reduction steps results in an irreducible graph, this is, a graph where no other reduction step is possible. In practice, one of the steps (a global one, involving division points) is hardly used (less than 1%), while being the computationally costlier of the two, and can be omitted. In experiments on the Gutenberg corpus, the method of Tealdi and Gallé is able to reconstruct chunks of an average length of 55.44 words, and an average maximal length of 658.34, starting from the corpus of all 5-grams.

To inhibit such a reconstruction from n-gram statistics, it has been proposed to remove some of the n-grams, for example, by removing all n-grams that occur less than a predefined threshold amount M. This approach has been applied on the Google Ngram corpus (see, Jean-Baptiste Michel, et al., “Quantitative analysis of culture using millions of digitized books,” Science, 331(6014):176-182, 2011, hereinafter “Michel”). Only less frequent evidence is eliminated, which may be less interesting for most applications. However, there are problems with this method. In particular, reconstruction is still possible for many fragments, most of which are correct. Additionally, the utility of such a corpus is greatly reduced for some applications. For example, the measured perplexity of a language model obtained from the corpus is decreased considerably.

There remains a need for a system and method for inhibiting the ability to reconstruct documents from their n-gram statistics while minimizing the impact on the usefulness of the statistics for other purposes.

### INCORPORATION BY REFERENCE

The following reference, the disclosure of which is incorporated herein in its entirety by reference, is mentioned:

U.S. application Ser. No. 14/083,483, filed on Nov. 19, 2013, entitled RECONSTRUCTING DOCUMENTS FROM n-GRAM INFORMATION, by Tealdi, et al.

### BRIEF DESCRIPTION

In accordance with one aspect of the exemplary embodiment, a method for modifying n-gram statistics includes obtaining n-gram statistics for a sequence of symbols. The n-gram statistics include, for each of a set of n-grams present in the sequence, an associated measure of occurrence in the sequence. An initial directed graph is generated from the n-gram statistics, the directed graph including nodes connected by edges, each edge corresponding to one of the n-grams in the set of n-grams and being associated with a multiplicity which is based on the measure of occurrence. A modified directed graph is generated. This includes adding a plurality of edges to the initial directed graph, the plurality of added edges corresponding to n-grams that are not present in the sequence of symbols and being each associated with a multiplicity. Modified n-gram statistics are generated for the modified graph. The modified n-gram statistics include, for n-grams represented in the graph, an associated measure of occurrence.

At least one of the generating an initial directed graph, generating a modified directed graph, and generating modified n-gram statistics from the modified directed graph may be performed with a processor.

In accordance with another aspect of the exemplary embodiment, a system for modifying n-gram statistics includes a graphing component for generating an initial directed graph from n-gram statistics for a set of n-grams. The initial directed graph including nodes connected by edges. Each edge corresponds to one of the n-grams in the set of n-grams and is associated with a multiplicity derived from the n-gram statistics. A modification component generates a modified directed graph. The modification component performs at least one of: a) for a plurality of iterations, selecting an irregular node from the directed graph and adding an edge to each of two other nodes of the directed graph, each added edge being associated with a multiplicity that reduces the irregularity of the irregular node, and b) for a plurality of iterations, selecting a regular node from the directed graph and adding an edge to each of two other nodes of the graph, each added edge being associated with a multiplicity that increases the irregularity of the regular node. A reconstruction component generates modified n-gram statistics for the modified graph, the modified n-gram statistics including, for n-grams represented in the modified directed graph, an associated measure of occurrence. A processor implements the graphing component, modification component, and reconstruction component.

In accordance with another aspect of the exemplary embodiment, a method for modifying n-gram statistics includes obtaining n-gram statistics for a sequence of symbols. The n-gram statistics include, for each of a set of n-grams present in the sequence, an associated measure of occurrence in the sequence. An initial directed graph is generated from the n-gram statistics. The initial directed graph includes nodes connected by edges. Each of the edges corresponds to one of the n-grams in the set of n-grams and is associated with a multiplicity which is based on the measure of occurrence. A modified directed graph is generated. This includes adding a plurality of edges to the initial directed graph, including at least one of: a) for a plurality of iterations, selecting an irregular node from the directed graph and adding an edge to each of two other nodes of the graph, each added edge being associated with a multiplicity that reduces the irregularity of the irregular node, and b) for a plurality of iterations, selecting a regular node from the directed graph and adding an edge to each of two other nodes of the graph, each added edge being associated with a multiplicity that increases the irregularity of the regular node. Modified n-gram statistics are generated for the modified directed graph. The modified n-gram statistics include, for n-grams represented in the graph, an associated measure of occurrence.

At least one of the generating an initial directed graph, generating a modified graph, and generating modified n-gram statistics from the modified graph may be performed with a processor.

### BRIEF DESCRIPTION OF THE DRAWINGS

FIG. 1 illustrates a system for modifying n-gram statistics in accordance with one exemplary embodiment;

FIG. 2 illustrates an example of application of the Pigeonhole rule;

FIG. 3 is a flow chart which illustrates a method for modifying n-gram statistics in accordance with another exemplary embodiment;

FIG. 4 illustrates exemplary modification steps in the method of FIG. 3;

FIG. 5 illustrates a simplified de Bruijn graph;

FIG. 6 illustrates addition of edges to a part of a Bruijn graph to decrease the irregularity value of an irregular node;

FIG. 7 illustrates addition of edges to a part of a Bruijn graph to increase the irregularity value of a node;

FIG. 8 is a plot showing the error rate in reconstruction of documents from n-gram statistics using the Pigeonhole rule after removing n-grams which occur less than a threshold number of times and after modifying edges of a Bruijn graph by the exemplary method, for different numbers of modified edges;

FIG. 9 is a plot of perplexity (ppx) of a language model obtained by removing all n-grams occurring fewer or equal than M times; and

FIG. 10 is a plot of perplexity of a language model obtained by running polishing and disturbing algorithms for different numbers of modifications (changing parameter K).

### DETAILED DESCRIPTION

In the exemplary system and method, n-grams are added in a non-deterministic way to n-gram statistics generated from a document or corpus of documents prior to release of the n-gram statistics.

It is assumed that the data to be released is text and that it takes the form of a corpus of n-grams. The goal is to inhibit the reconstruction of larger chunks of text than the released n-grams from the released n-gram statistics while maintaining the utility of the statistics. While the utility may vary from application to application, as an example, the construction of a traditional language model is considered, as a very generic but still concrete usage. Language Models are used in several applications, such as machine translation, speech recognition and other document-access uses.

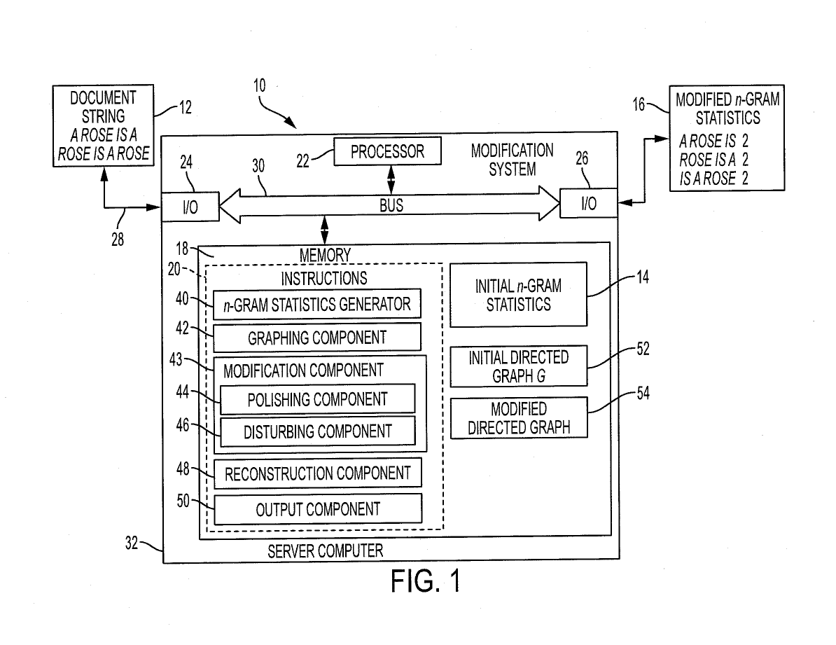

With reference to FIG. 1, a computer-implemented system 10 for modifying n-gram statistics is shown. An input string (or sequence) 12 is a sequence of symbols drawn from an alphabet of symbols. In the exemplary embodiment, the symbols each represent a respective word and the sequence is a sequence of words forming a document or document corpus (optionally preprocessed). From the document string 12, initial n-gram statistics 14 are generated for all n-grams of a selected length n, where n is at least 2, and may be, for example, 2, 3, 4, or 5, and may be up to 100, or up to 10. The system generates modified n-gram statistics 16 from the initial statistics 14, which are output and suitable for various uses, such as generation of a language model.

The system includes memory 18 which stores instructions 20 for performing the exemplary method and a processor 22 in communication with the memory for executing the instructions. One or more input/output (I/O) interfaces 24, 26 allow the system to communicate with external devices via a link 28, such as a wired or wireless network, such as the Internet. Hardware components 18, 22, 24, 26 of the system communicate via a data/control bus 30. The system may be hosted by one or more computing devices 32.

The instructions 20 include an n-gram statistics generator 40, a graphing component 42, a modification component 43 including one or more n-gram statistics modification components 44, 46, a reconstruction component 48, and an output component 50. The statistics generator 40 generates initial n-gram statistics 14 from an input text string 12, if this has not already been performed. The graphing component 42 generates a directed graph, specifically a de Bruijn graph 52, from the initial n-gram statistics 14. The exemplary more n-gram statistics modification components 44, 46 include a polishing component 44 and a disturbing component 46, which modify edges of the graph 52 to generate a modified directed graph 54, as described in greater detail below. The reconstruction component 48 computes the n-gram statistics 16 of the modified graph 54. The modified n-gram statistics include, for each n-gram represented in the modified graph 54, an associated measure of occurrence, such as a count, although in this case, at least some of the counts do not correspond to a count of the respective n-gram in the text string 12, which is zero in some instances. The output component 50 outputs the modified n-gram statistics 16.

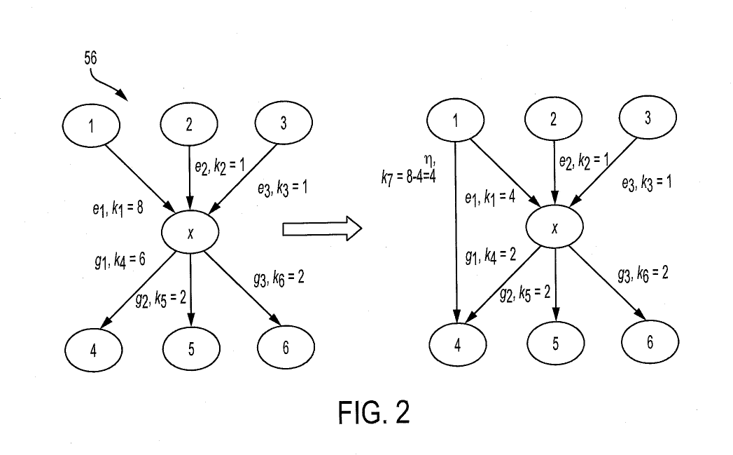

A Bruijn graph 52, denoted G, is readily constructed from n-gram statistics 14. In the graph, each n-gram becomes an edge between two nodes, each one denoting an n−1-gram. Each edge is associated with a multiplicity, denoting the number of times the n-gram occurs in the n-gram statistics 14. Each multiplicity is thus an integer' value which is greater than 0, such as 1, 2, 3, or 4, etc. For each node x in a de Bruijn graph, there is at least one incoming edge eᵢ with multiplicity kᵢ and at least one outgoing edge eᵢ with multiplicity kⱼ. FIG. 2 is an illustrative example which shows the complete local context 56 of a node x of a de Bruijn graph 52, which has incoming edges eᵢ=e₁, e₂, and e₃ and outgoing edges gⱼ=g₁, g₂, and g₃, each with an associated multiplicity. An incoming edge is one that terminates at the node (the node is the last n-1 symbols of the n-gram represented by that edge). An outgoing edge is one that begins at the node (the node is the first n-1 symbols of the n-gram represented by that edge). As will be appreciated, nodes 1-6 are, in turn, connected to other nodes of the graph 52.

The indegree dᵢₙ(x) of a node x of the graph is defined as Σ_{e∈E:head(e)=x}multiplicity (e) i.e., the sum, over all incoming edges, of their multiplicity, and the outdegree dₒᵤₜ(x) of a node x is defined as Σ_{g∈E:tail(g)=x}multiplicity (g), i.e., the sum, over all outgoing edges, of their multiplicity. A graph is Eulerian if it is connected and dᵢₙ(x)=dₒᵤₜ(x) for all nodes x. In this case, the degree of the node d(x)=dᵢₙ(x)=dₒᵤₜ(x). For node x in FIG. 2, for example, dᵢₙ(x)=dₒᵤₜ(x)=8+1+1=6+2+2=10.

An Eulerian cycle through the de Bruijn graph is a cycle that visits each edge e exactly multiplicity(e) times. The set of all Eulerian cycles of G is denoted by ec(G). Given one such Eulerian cycle, its label sequence is the list of labels of its edges and the sequence it represents is the concatenation of these labels.

Without the modifications described herein, given the statistics 14, some reconstruction of the original corpus 12 is feasible, using, for example, the method of Tealdi and Gallé. One local rule applied to the de Bruijn graph in that method is referred to as the Pigeonhole Rule, which is illustrated in the example shown in FIG. 2. Consider the eight times that any Eulerian cycle will use edge e₁. Even if in four of these cases, the path through the graph continues with g₂ or g₃, this still leaves four times where the only remaining option is to leave through edge g₁. Therefore e₁⊙g₁ has to occur at least four times, which can be shown as a new edge η between nodes 1 and 4, denoting a text subsequence longer than n, with a multiplicity of 4. The multiplicities of edges e₁ and g₁ are each reduced by the value of the multiplicity of the new edge η. In the above, ⊙ denotes a concatenation of strings where the trailing n-1 characters of the first string are ignored, e.g., abcd ⊙ bcde=abcde.

More generally, for any node x, with incoming edges eᵢ, outgoing edges gⱼ and their respective multiplicities kᵢ,kⱼ, the Pigeonhole rule is applied whenever kᵢ>d(x)−kⱼ(or kⱼ>d(x)−kᵢ), where d(x) denotes the degree of the node x. These nodes are referred to as irregular nodes. For an irregular node of the graph, the irregularity value is defined as:

δ(x)=max_{e∈incoming(x)}multiplicity(e)+max_{g∈outgoing(x)}multiplicity(g)−d(x)>0. (1)

i.e., the sum of the multiplicity of the incoming edge e with the highest multiplicity and the multiplicity of the outgoing edge g with the highest multiplicity minus the degree of the node has a value of δ(x) which is greater than 0. The irregularity values of irregular nodes are thus integer values, such as 1, 2, 3, etc. In general a range of irregularity values is present in the initial graph 52.

As an example, consider the node x in FIG. 2. The incoming edge with the highest multiplicity is edge e₁, with a multiplicity of 8 and the outgoing edge with the highest multiplicity is edge g₁, with a multiplicity of 6. The degree d(x) of the node x is 10. The irregularity value δ(x) of the node is 6+8−10=2, which is greater than 0 so the node is classed as irregular.

In the exemplary system and method, instead of removing infrequent n-grams to obfuscate the data as in the method of Michel, n-grams are added in a strategic and non-deterministic way. The system and method specifically targets the application of the Pigeonhole rule. The exemplary system and method operate by polishing irregular nodes so that they become regular and/or by disturbing nodes of any type, creating false irregular nodes.

The computer-implemented system 10 may include one or more computing devices 32, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 18 may represent any type of non-transitory computer readable medium such as random access memory (RAM), read only memory (ROM), magnetic disk or tape, optical disk, flash memory, or holographic memory. In one embodiment, the memory 18 comprises a combination of random access memory and read only memory. In some embodiments, the processor 22 and memory 18 may be combined in a single chip. Memory 18 stores instructions for performing the exemplary method as well as the processed data 14, 52, 54.

The network interface 24, 26 allows the computer to communicate with other devices via a computer network, such as a local area network (LAN) or wide area network (WAN), or the internet, and may comprise a modulator/demodulator (MODEM) a router, a cable, and and/or Ethernet port.

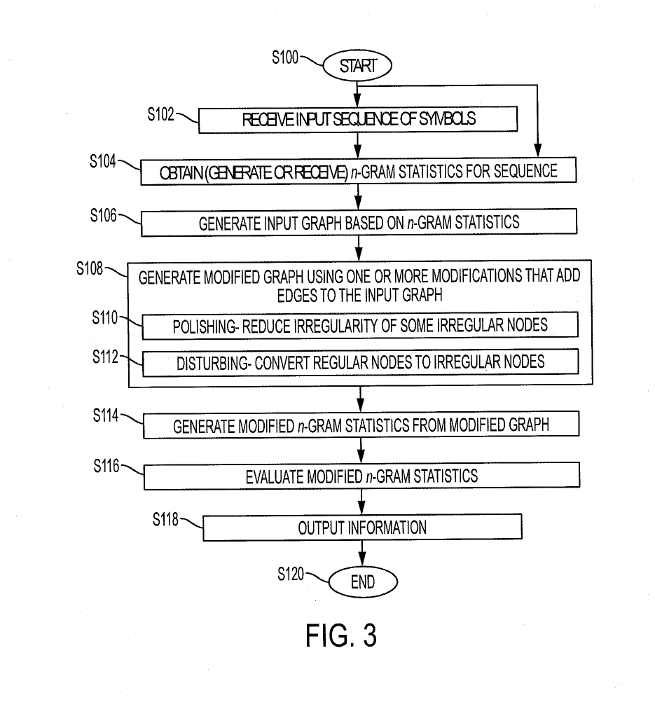

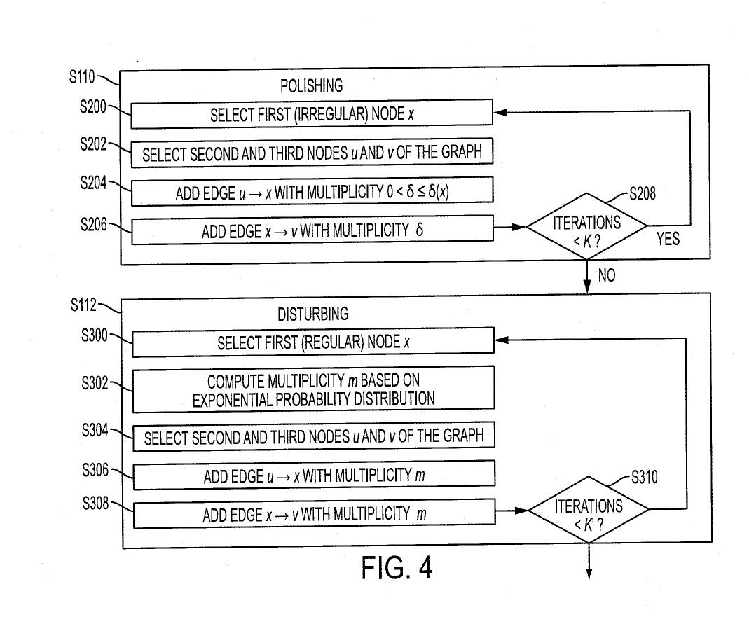

The digital processor 22 can be variously embodied, such as by a single-core processor, a dual-core processor (or more generally by a multiple-core processor), a digital processor and cooperating math coprocessor, a digital controller, or the like. The digital processor 22, in addition to controlling the operation of the computer 32, executes instructions stored in memory 18 for performing the method outlined in FIGS. 3 and 4.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

FIG. 3 illustrates a method for modifying n-gram statistics. The method begins at S100.

At S102, a text string 12 is received, such as a sequence of words forming a document or a document corpus.

At S104, from the string 12, initial n-gram statistics 14 (a list of n-grams and their respective counts in the sequence 12) are obtained. In one embodiment, they are generated by the statistics generator 40. In another embodiment, there is no access provided to the original document(s) 12 and the n-gram statistics 14 are received from an external source that has access to the original document(s) from which the n-grams statistics are generated.

At S106, an input directed (de Bruijn) graph 52 is generated, based on the initial n-gram statistics 14.

At S108, the input graph 52 is modified a plurality of times using one or both of the modification methods (polishing S110, and disturbing S112), to generate a modified graph 54. This may be performed by one or both of the modification component(s) 44, 46. S110 and S112 are described in greater detail below with reference to FIG. 4. When the modifications have been completed, the resulting modified graph 54 includes some nodes (e.g., regular nodes) that are each derived from a respective irregular node in the initial graph for which an irregularity value of the respective irregular node is modified (e.g., reduced), and/or some irregular nodes that are each derived from a respective regular node in the initial graph.

At S114, the modified graph 54 is processed, by the reconstruction component 48, to identify the modified n-gram statistics 16 corresponding to some or all of the edges of the modified graph 54 and the multiplicities of these edges.

Optionally, at S116, the statistics 16 may be evaluated, for example, by computing the error rate for reconstruction of sequences longer than n from the modified n-gram statistics 16 (using the method of Tealdi and Gallé, for example) and/or by measuring the perplexity of a language model generated from the modified n-gram statistics, as described, for example, in the Examples below. This may be used to confirm that the statistics would not reveal too much of the original text sequence on the one hand, and on the other, are useful for their intended purpose. In the event that the reconstruction error is not low enough, the method may return to S108 for further iterations of S110 and/or S112 to be performed on the modified graph.

At S118, information is output which may include or be based on the modified statistics 16.

The method ends at S120.

Aspects of the exemplary system and method will now be described in further detail.

Creation of n-gram Statistics (S104)

n-gram statistics 14 can be generated from a text document or document corpus 12. The words (unigrams) can be automatically identified in a text document based on the white spaces between them. The extraction of n-gram statistics may include generating a document-length sequence, which may include adding unique beginning and ending symbols which do not appear as symbols (words) in the document (here illustrated by “$” and “#”). For example, given a very small document which consists solely of the famous quote: A rose is a rose is a rose, based on Gertrude Stein's poem, the document-length sequence generated is $ A rose is a rose is a rose #. Then, starting at a first end, all possible n-grams are extracted, i.e., including overlapping n-grams. For each n-gram, a measure of occurrence, such as count of the number of occurrences in the text sequence 12, is stored. For example, if n is 3, the n-gram statistics would be as shown in TABLE 1:

TABLE 1

| n-gram | Number of occurrences k |
|---|---|
| $ a rose | 1 |
| a rose is | 2 |
| rose is a | 2 |
| is a rose | 2 |
| a rose # | 1 |

As will be appreciated, the n-grams may be listed in any order, such as alphabetical order, number of occurrences, or randomly. While the list is illustrated as a table, any suitable data structure may be employed for storing the n-gram statistics.

In the case of two or more documents, their sequences may be concatenated. Punctuation, capitalization, and/or numbers may be ignored in some embodiments. Other pre-processing may also be performed.

### Creation of Input Graph (S106)

Various methods and software packages exist for creation of an initial de Bruijn graph 52 based on n-gram statistics 14. See, for example, Compeau, et al., “How to apply de Bruijn graphs to genome assembly,” Nature Biotechnology 29(11) 987-991 (2011); and Weisstein, Eric W., “De Bruijn Graph”, from MathWorld (http://mathworld.wolfram.com/deBruijnGraph.html).

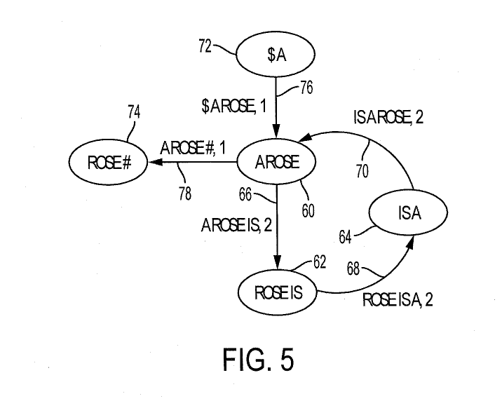

For example, as illustrated in FIG. 5, a node 60, 62, 64 is created for the n-1 gram of each n-gram initially present in the n-gram list. Thus, no two nodes are the same. In the case of the list shown in TABLE 1, a node is created for a rose, rose is, and is a, which each correspond to the first two words (symbols) of a respective trigram in the list. Each node is connected by a directed edge 66, 68, 70 to each other node (or to itself) for which there is an n-gram in the list in which the two node values (here, bigrams) are present, one at the beginning and the other at the end of the n-gram. The edge is labeled with the number of occurrences (multiplicity) k of this n-gram in the n-gram statistics. The terminal nodes 72, 74 corresponding to $ a and rose # are not considered as part of the graph, but are merely used to provide an incoming (resp. outgoing) edge 76, 78 for the node(s) 60 to which they are connected.

### Modification of the Input Graph (S108)

The input graph is modified by adding edges eᵢ,gⱼ to the graph with associated multiplicities k. This is achieved by performing polishing and disturbing steps S110, S112, each of which is performed a number of times. While in the illustrated embodiments, all of the polishing iterations (S110) are performed prior to the disturbing iterations (S112), the order can differ. For example, one or more polishing iterations may be preceded and/or followed by one or more disturbing iterations. The total number of added edges may be, for example, at least 0.5%, or at least 1%, or at least 2% or at least 5% of the number of edges in the initial graph, such as at least 100, or at least 1000 or at least 10000 added edges, or more, depending on the size of the text sequence.

### Polishing Nodes (S110)

In the polishing stage, some (but not all) of the irregular nodes, as defined according to Eqn. 1 above, are converted into regular nodes or are made less irregular, by reducing their irregularity value δ(x). This is achieved by adding new edges to the graph.

Step S110 is illustrated in the flow chart shown in FIG. 4. At S200, an irregular node is selected x, e.g., drawn randomly, from all irregular nodes in the current directed graph 14 (the initial directed graph or a directed graph which has been modified by prior iterations). At S202, two other nodes u and v are selected, e.g., drawn randomly, from the nodes in the graph that are capable of being joined by respective input and output edges to x (if no such nodes are found, the method may return to S200, where a new irregular node is selected). The two nodes u and v may be irregular or regular nodes. For each of the nodes u and v, an edge is created to the irregular node x (S204, S206), specifically, an incoming edge from u to x and an outgoing edge from x to v. Each edge has the same multiplicity δ, which is no greater than the irregularity value of the node δ(x). If at S208, a predefined number K of polishing steps has not yet been performed, the method returns to S200 for another iteration of S200-S206, else to S112.

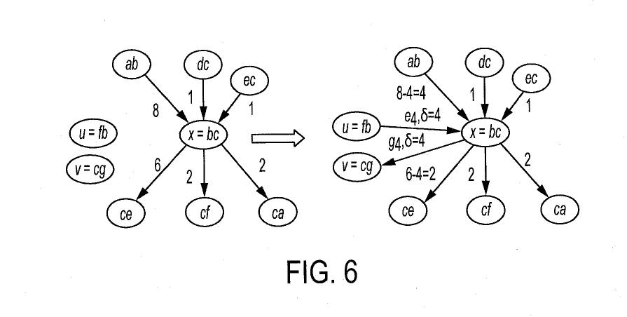

An example of a polishing iteration is illustrated in FIG. 6, where the edges represent trigrams and the nodes their terminating bigrams. Assume that the graph 52 of which an irregular node x (denoting two words represented by symbols bc) is a part also includes two nodes u and v, which denote the words fb and cg respectively. These nodes are chosen at random from the nodes which terminate in b and begin with c, respectively. In the exemplary embodiment, the other nodes u and v are not directly connected to node x. Two new edges e₄, g₄ are created, one an incoming edge and one an outgoing edge, which connect the irregular node x with the respective existing nodes u and v of the graph. A multiplicity δ is assigned to each of the new edges. The multiplicity can be up to δ(x), which in the illustrated case is 4. Each new edge e₄, g₄ added in the polishing iteration has the same multiplicity δ=4. As will be appreciated, this creates two new false n-grams, which were not observed in the document/corpus 12. In the case of FIG. 6, the new n-grams are the sequences fbc and bcg. Accordingly, these new trigrams and their multiplicities will appear in the output statistics 16 as indistinguishable from other trigrams with their multiplicities. As will be appreciated, further modifications could be made to the node x in subsequent iterations.

Algorithm 1 illustrates an exemplary implementation of the polishing method. A value for two parameters are selected: K, the number of iterations, and a maximum value of δ, denoted δₘₐₓ.

Algorithm 1 Polishing of irregular nodes

| polish (K, δₘₐₓ) | |
|---|---|
| 1. for K times do | |
| 2. | x = pick up a random irregular node |
| 3. | δ = min(δ(x), δₘₐₓ) |
| 4. | u, v = pick up two random nodes |
| 5. | add edges (u, x, δ) and (x, v, δ) |

6. end for

The algorithm adds 2K edges to the graph (2 at each iteration), converting, at most, K nodes into regular ones. In order not to add a false n-gram with too large a multiplicity, the multiplicity δ is thresholded by the parameter δₘₐₓ. This provides an upper bound for multiplicity δ, i.e., to be no greater than δₘₐₓ. In the exemplary Algorithm, δ is selected as the minimum of the two values δₘₐₓ and δ(x) (although it could be even smaller). If δₘₐₓ is large, it has little or no impact on the result. In one embodiment, δₘₐₓ may be selected by observing the effect of different values of δₘₐₓ on performance. In another embodiment, it may be selected to be up to a certain multiple of the average multiplicity over the n-gram statistics, e.g., ≦5×average k or ≦2×average k, or ≦0.5×average k. In another embodiment δₘₐₓ may be a user-selectable parameter. As an example, such as up to 50, or up to 20, or up to 10, or up to 6.

K can be selected to provide a high error rate for reconstructing the original sequence, given the n-gram statistics, while at the same time, maintaining the usefulness of the data, which can be measured in terms of perplexity (a measurement of how well a language model generated from the statistics 16 predicts the next word of the original sequence). The selection of K is a tradeoff and a suitable value may be determined by evaluating the two objectives for different values of K. K may be, for example at least 0.1% or at least 0.5% or at least 1% of the number of edges in the initial graph, such as at least 10, or at least 20, or at least 50, or at least 100, or at least 1000, or more.

The added edges do not increase the degree of node x. The exemplary algorithm breaks the Eulerian nature of the graph (requiring that all nodes are balanced, i.e., dᵢₙ(x)=dₒᵤₜ(x)). In particular, although node x is still balanced, nodes u and v have an additional single edge which makes their incoming and outgoing degrees different. One way to avoid this is by grouping all K₁ nodes by their δ(x) and creating an Eulerian cycle for each group.

### Disturbing Nodes (S112)

In addition to (or as an alternative to) removing/reducing irregularities in the graph as described for S110, another way of misleading the application of the Pigeonhole rule is by creating false irregular nodes. To do so, edges are added so that δ(x) of a regular node becomes positive. This step converts some (but not all) of the regular nodes of the graph to irregular ones. The method is illustrated in FIG. 4. At S300, a regular node x is sampled from the current graph (the initial directed graph or a directed graph which has been modified by prior iterations). At S302, a multiplicity for two new edges for x is computed based on an exponential probability distribution. This can be done, for example, by adding edges with multiplicity that is a function of d(x)+p, where p is a positive value. In one embodiment, p is drawn from an exponential probability distribution (expλ) in which the probability decreases with increasing values of p. For example, for λ=0.5, the distribution is such that probability of p being 0 is 0.39, of being 1 is 0.23, of being 2 is 0.144, and so forth.

At S304, two other nodes u and v are selected, e.g., drawn randomly, from the nodes in the graph. These two nodes may be irregular or regular nodes. For each of nodes u and v, an edge is created to the irregular node x (S306, S308). Each edge has the same multiplicity m. If at S310, a predefined number K′ of disturbing iterations has not yet been performed, the method returns to S300 for another iteration of S300-S308, else to S114.

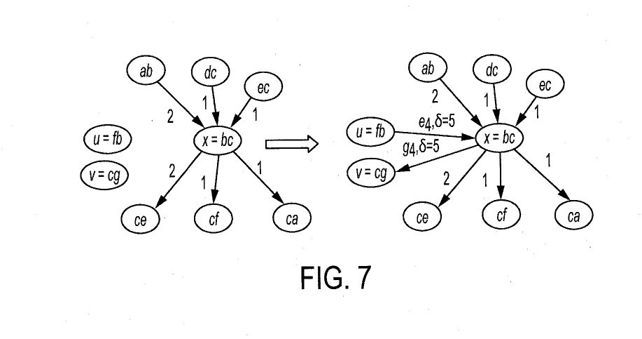

An example of a polishing iteration is illustrated in FIG. 7, where the edges represent trigrams and the nodes their terminating bigrams, as discussed for FIG. 6. In this case node x is a regular node, i.e., δ(x)=0. Two nodes u and v are chosen at random from the nodes which terminate in b and begin with c, respectively. In the exemplary embodiment, the other nodes u and v are not directly connected to node x. Two new edges e₄, g₄ are created, one an incoming edge and one an outgoing edge, which connect the regular node x with the respective existing nodes u and v of the graph. A multiplicity δ is assigned to each of the new edges which increases δ(x), making node x irregular. Each new edge e₄, g₄ added in the polishing iteration has the same multiplicity, δ=5 in the illustrative example. The added edges do increase the degree of node x in the disturbing case. As for the polishing, it is desirable that the multiplicities of the false edges not be too high. The multiplicity can range between a minimum value of d(x)+1 and a large value, which can be controlled by modifying the exponential probability distribution so that it is zero for large multiplicities. As for the polishing, this creates two new false n-grams, which were not observed in the document/corpus 12. In the case of FIG. 7, the new n-grams are the sequences fbc and bcg. Accordingly, these new trigrams and their multiplicities will appear in the output statistics 16 as indistinguishable from other trigrams with their multiplicities. As will be appreciated, further modifications could be made to the node x in subsequent iterations.

Algorithm 2 shows one method for performing the disturbing step S112.

Algorithm 2 Creating irregular nodes

| disturb (K′, λ) | |
|---|---|
| 1. for K′ times do | |
| 2. | x = pick up a random node |
| 3. | p~exp(λ) |
| 4. | m = d(x) + └p┘ + 1 |
| 5. | u, v = pick up two random nodes |
| 6. | add edges (u, x, m) and (x, v, m) |
| 7. | end for |

The Algorithm takes as input a number of iterations K′ and a value λ. A suitable value of K′ may be selected as for K. K′ may be, for example at least 0.1% or at least 0.5% or at least 1% of the number of edges in the initial graph, such as at least 10, or at least 20, or at least 50, or at least 100, or at least 1000, or more. In some embodiments, K=K′, although it is to be appreciated that different values can be selected.

In step 2 of the Algorithm, a random node is selected which may be regular or irregular, although in other embodiments, the node x is selected from only regular nodes of the graph.

At step 3, p is chosen using the probability distribution exp(λ). At step 4, the multiplicity m is computed as the degree of node x, plus the floor of p (to convert p to the next lowest integer) plus 1, to ensure that the multiplicity is always greater than the degree of node x. Steps 5 and 6 proceed as for steps 4 and 5 of Algorithm 1.

In some embodiments, the modification methods can be modified slightly in order to keep each node balanced (indegree=outdegree), therefore hiding the fact that the corpus has been modified at all. In one embodiment, these modifications may be performed on the graph after the polishing and disturbing steps are complete. This can be performed by adjusting, as far as reasonably feasible, the multiplicities of those nodes for which indegree ≠ outdegree while maintaining the irregularity value δ(x) of the node.

The exemplary system and method thus add noise to a corpus of n-grams in a way which (1) inhibits the reconstruction of substrings larger than those disclosed in the n-gram statistics while (2) maintaining the utility of the corpus, as measured by the quality of a language model obtained from it. The noise is added to focus on the irregular nodes, which are the key nodes for inferring larger substrings. The irregularity value of a random set of those nodes is removed/reduced and false irregularities are created by making regular nodes irregular (and, potentially, by making irregular nodes more irregular).

The method illustrated in FIGS. 3 and 4 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 32, (for example, an internal hard drive of RAM), or may be separate (for example, an external hard drive operatively connected with the computer 32), or may be separate and accessed via a digital data network such as a local area network (LAN) or the Internet (for example, as a redundant array of inexpensive of independent disks (RAID) or other network server storage that is indirectly accessed by the computer 32, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIGS. 3 and/or 4, can be used to implement the method for modification of n-gram statistics. As will be appreciated, while the steps of the method may all be computer implemented, in some embodiments one or more of the steps may be at least partially performed manually.

As will be appreciated, the steps of the method need not all proceed in the order illustrated and fewer, more, or different steps may be performed.

Without intending to limit the scope of the exemplary embodiment, the following examples demonstrate the applicability of the method using a set of documents.

### EXAMPLES

A random sample of 100 books was taken from the Gutenberg project (https://www.gutenberg.org/). All of the 5-grams were extracted from these books and their statistics generated.

First, the robustness of the reconstruction method of Tealdi and Gallé was evaluated, when the approach Michel is taken for removing all n-grams occurring less than M times. M ranged from 1 to 10. The method of Tealdi and Gallé ensures that all obtained chunks are correct, but only if the underlying graph is complete, meaning it reflects exactly all n-grams and their count. However, the method still can yield many correct chunks even when the dataset is incomplete. This is demonstrated by running the method on the incomplete dataset and determining what proportion of the reconstructed chunks are actually correct. Ideally, a significant proportion of the reconstructed chunks should be wrong so that a potential attacker is not able to trust the outcome of the reconstruction.

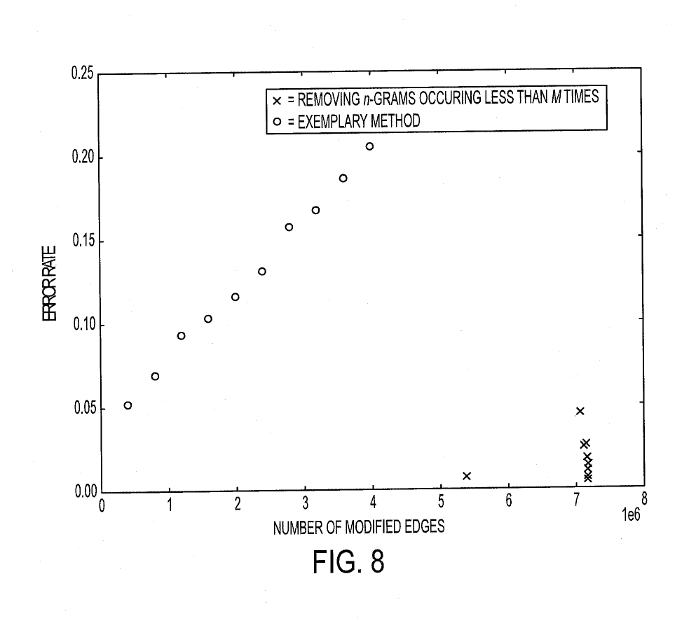

The presence of reconstructed subsequences longer than 5 words that are present in the original text was evaluated (for efficiency reasons a random sample of 1000 reconstructed subsequences was employed). The results are shown in FIG. 8. The x-axis of the graph corresponds to the number of n-grams that were removed and the y-axis to the error rate. For this method, the error rate decreases with increasing number of removed n-grams, partly because there are fewer chunks in general, and more of them seem to be correct. As can been seen, in none of the cases is the error rate above about 5%, meaning that 95% of the reconstructed chunks correspond to real substrings of the text.

This was compared the exemplary method described above. For simplicity the same value of K (i.e., K=K′) is used for Algorithms 1 and 2, resulting in an addition of a total of 4K edges. δₘₐₓ was set to 20 and λ to 0.5. The error rate of the method is also shown in FIG. 8 for different numbers of modified edges. With a much lower number of modified edges than in the standard method, a much higher error rate is achieved, reaching 20% with K=200,000 iterations for each Algorithm.

In the exemplary method, the aim is not simply to hinder reconstruction, but also to allow the dataset to be useful if released in that manner. To provide a measure of the utility, it is assumed that the goal is to construct a language model out of the collected n-grams, a goal that covers many different applications. The perplexity of a language model created of the modified corpora (either through removing edges, as in the method of Michel, or by adding edges in the present method) is thus evaluated. For this purpose, the CMU-Cambridge Statistical Language Modeling Toolkit v2 was used (http://svr-www.eng.cam.ac.uk/prc14/toolkit.html, described in CLARKSON, et al., “Statistical Language Modeling Using the CMU-Cambridge Toolkit,” Proc. ESCA Eurospeech 1997), with default options (Good-Turing discounting is used).

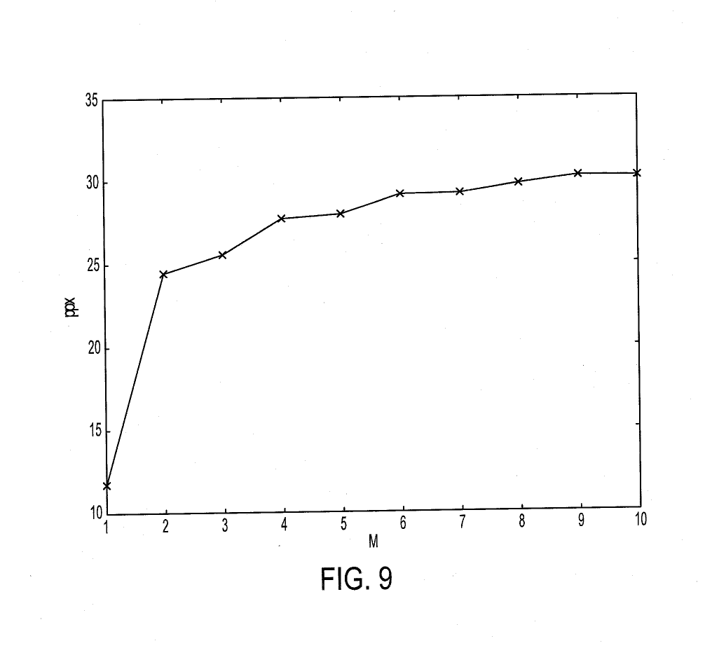

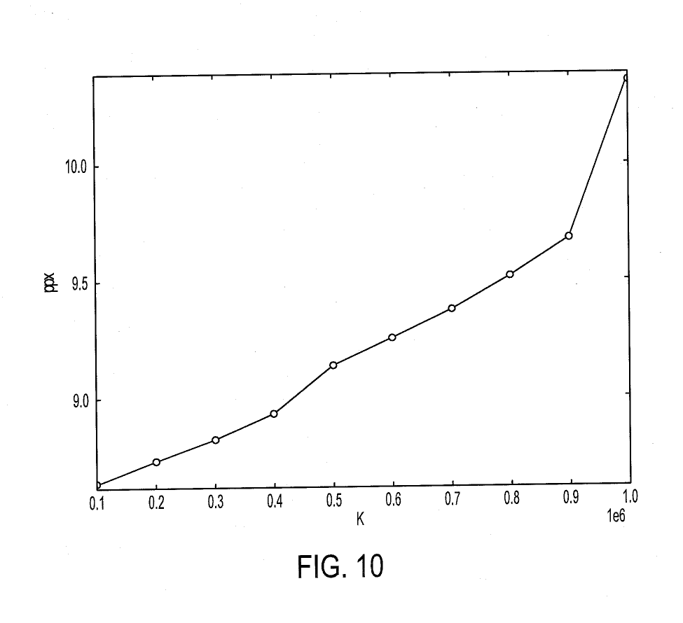

For testing, an additional 100 random books (not contained in the ones used to create the modified n-gram statistics) were used and average perplexity (ppx) is shown for the language models in FIGS. 9 and 10. FIG. 9 shows the results for language models obtained by removing n-grams occurring less than M times, with M ranging from 0-10. It can be seen that the perplexity deteriorates (increases) quickly when removing less frequent n-grams. FIG. 10 shows the results for language models generated with the n-gram statistics obtained by the exemplary method. It can be seen that in adding edges, the deterioration is not only less acute, but also more gentle, making it easier to control.

It should be noted that the baseline perplexity, corresponding to M=0, is 7.55, which is only slightly lower than the values obtained by adding edges.

The evaluations suggest that the exemplary method for adding n-grams performs better than the standard method of removing less-frequent n-grams. First, the inferred substrings using the method of Tealdi and Gallé are more likely to be wrong. Second, the utility of the modified n-gram corpus for language modeling is only slightly worse, with respect to learning the language model, than the perfect information.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for modifying n-gram statistics comprising:
obtaining n-gram statistics for a sequence of symbols, the n-gram statistics comprising, for each of a set of n-grams present in the sequence, an associated measure of occurrence in the sequence;
generating an initial directed graph from the n-gram statistics, the initial directed graph including nodes connected by edges, each of the edges corresponding to one of the n-grams in the set of n-grams and being associated with a multiplicity which is based on the measure of occurrence;
generating a modified directed graph comprising adding a plurality of edges to the initial directed graph, the plurality of added edges corresponding to n-grams that are not present in the sequence of symbols and being each associated with a multiplicity; and
generating modified n-gram statistics for the modified directed graph, the modified n-gram statistics comprising, for n-grams represented in the modified directed graph, an associated measure of occurrence,
wherein at least one of the generating an initial directed graph, generating a modified directed graph, and generating modified n-gram statistics from the modified graph is performed with a processor.

2. The method of claim 1, wherein each node of the graph has at least one incoming edge and at least one outgoing edge and wherein the irregularity value of a node is a sum of a multiplicity of the incoming edge of the node having a highest multiplicity and a multiplicity of the outgoing edge of the node having a highest multiplicity minus a degree of the node, the degree being computed as a sum of the multiplicities of each of the incoming edges of the node or a sum of the multiplicities of each of the outgoing edges of the node, and wherein an irregular node has an irregularity value which is greater than 0.

3. The method of claim 1, wherein each node of the graph has at least one incoming edge and at least one outgoing edge and represents at least a first symbol of an n-gram represented by each of its outgoing edges and at least a last symbol of an n-gram represented by each of its incoming edges.

4. The method of claim 1, wherein the modified graph includes at least one of:
nodes derived from a respective irregular node in the initial graph for which an irregularity value of the respective irregular node is modified, and
irregular nodes derived from a respective regular node in the initial graph.

5. The method of claim 1, wherein the generating a modified directed graph comprises, for each of a plurality of iterations:
selecting a first node of the graph, the first node being an irregular node;
selecting second and third nodes of the graph;
generating an incoming edge from the second node to the first node;
generating an outgoing edge to the third node from the first node; and
assigning a multiplicity to the incoming edge and the outgoing edge, the assigned multiplicity being no greater than the irregularity value of the first node.

6. The method of claim 5, wherein the selecting of the second and third nodes of the graph comprises randomly selecting the second node from nodes of the graph representing at least a first symbol of the n-gram represented by the incoming edge and randomly selecting the third node from nodes of the graph representing at least a last symbol of the n-gram represented by the outgoing edge.

7. The method of claim 5, wherein the assigned multiplicity is a minimum of the irregularity value of the first node and a defined threshold value.

8. The method of claim 1, wherein the generating a modified directed graph comprises, for each of a plurality of iterations:
selecting a first node of the graph;
selecting second and third nodes of the graph;
generating an incoming edge from the second node to the first node;
generating an outgoing edge to the third node from the first node; and
assigning a multiplicity to the incoming edge and the outgoing edge, the assigned multiplicity being a function of a probability distribution.

9. The method of claim 8, wherein the first node is randomly selected from regular nodes of the graph.

10. The method of claim 8, wherein the selecting of the second and third nodes of the graph comprises randomly selecting the second node from nodes of the graph representing at least a first symbol of the n-gram represented by the incoming edge and randomly selecting the third node from nodes of the graph representing at least a last symbol of the n-gram represented by the outgoing edge.

11. The method of claim 1, wherein the generating a modified directed graph comprises, for each of a plurality of iterations, adding a pair of edges to the graph, the pair of edges comprising an incoming edge and an outgoing edge for a same node, and assigning a multiplicity to the incoming edge and the outgoing edge.

12. The method of claim 11, wherein for at least some of the plurality of iterations, the node is an irregular node.

13. The method of claim 12, wherein for at least some of the plurality of iterations, the irregular node is converted to a regular node.

14. The method of claim 1, further comprising outputting the modified n-gram statistics.

15. The method of claim 1, wherein the obtaining of the n-gram statistics comprises generating the n-gram statistics from the sequence of symbols.

16. The method of claim 1, wherein the sequence of symbols is a text sequence.

17. The method of claim 1, wherein the measure of occurrence in the sequence is a count of the respective n-gram in the sequence and each multiplicity in the initial directed graph is the count of the respective n-gram.

18. A computer program product comprising non-transitory memory storing instructions which, when executed by a computer, perform the method of claim 1.

19. A system comprising memory which stores instructions for performing the method of claim 1 and a processor in communication with the memory for executing the instructions.

20. A system for modifying n-gram statistics comprising:
a graphing component for generating an initial directed graph from n-gram statistics for a set of n-grams, the initial directed graph including nodes connected by edges, each of the edges corresponding to one of the n-grams in the set of n-grams and being associated with a multiplicity derived from the n-gram statistics;
a modification component for generating a modified directed graph, the modification component performing at least one of:
for a plurality of iterations, selecting an irregular node from the directed graph and adding an edge to each of two other nodes of the directed graph, each added edge being associated with a multiplicity that reduces the irregularity of the irregular node, and
for a plurality of iterations, selecting a regular node from the directed graph and adding an edge to each of two other nodes of the graph, each added edge being associated with a multiplicity that increases the irregularity of the regular node; and
a reconstruction component which generates modified n-gram statistics for the modified directed graph, the modified n-gram statistics comprising, for n-grams represented in the modified directed graph, an associated measure of occurrence; and
a processor which implements the graphing component, modification component, and reconstruction component.

21. A method for modifying n-gram statistics comprising:
obtaining n-gram statistics for a sequence of symbols, the n-gram statistics comprising, for each of a set of n-grams present in the sequence, an associated measure of occurrence in the sequence;
generating an initial directed graph from the n-gram statistics, the initial directed graph including nodes connected by edges, each of the edges corresponding to one of the n-grams in the set of n-grams and being associated with a multiplicity which is based on the measure of occurrence;
generating a modified directed graph comprising adding a plurality of edges to the initial directed graph, including at least one of:
for a plurality of iterations, selecting an irregular node from the directed graph and adding an edge to each of two other nodes of the directed graph, each added edge being associated with a multiplicity that reduces the irregularity of the irregular node, and
for a plurality of iterations, selecting a regular node from the directed graph and adding an edge to each of two other nodes of the graph, each added edge being associated with a multiplicity that increases the irregularity of the regular node; and
generating modified n-gram statistics for the modified directed graph, the modified n-gram statistics comprising, for n-grams represented in the modified directed graph, an associated measure of occurrence,
wherein at least one of the generating an initial directed graph, generating a modified directed graph, and generating modified n-gram statistics from the modified directed graph is performed with a processor.
